(19) United States
(12) Patent Application Publication
(10) Pub. No.: US 2010/0133940 A1
(43) Pub. Date: Jun. 3, 2010

(54) THREE-PHASE DYNAMOELECTRICAL PERMANENTLY EXCITED SYNCHRONOUS MACHINE

(75) Inventors: UDO GROSSMANN, Oberstreu (DE); Holger Schunk, Lendershausen (DE); Rolf Vollmer, Gersfeld (DE); Michael Zastrow, Salz (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/627,427

(22) Filed: Nov. 30, 2009

(30) Foreign Application Priority Data
Dec. 1, 2008 (EP) EP08020838

(51) Int. Cl. H02K 1/17

(52) U.S. Cl. 310/156.46; 310/156.47

(57) ABSTRACT

A three-phase dynamoelectrical permanently excited synchronous machine includes a stator with teeth which point to a rotor, wherein twelve slots are formed between the teeth. The slots have coil sides of coils of a winding system in such a manner that two coil sides of different coils are situated in each slot. The rotor has a cylindrical support structure which is provided with permanent magnets defined by an inner radius which corresponds to a radius of the support structure, and by an outer radius which is smaller than their inner radius. The permanent magnets are formed with ten magnet poles when viewed in a circumferential direction.

### CROSS-REFERENCES TO RELATED APPLICATIONS

This application claims the priority of European Patent Application, Serial No. EP 08020838, filed Dec. 1, 2008, pursuant to 35 U.S.C. 119(a)-(d), the content of which is incorporated herein by reference in its entirety as if fully set forth herein.

### BACKGROUND OF THE INVENTION

The present invention relates to a three-phase dynamoelectrical permanently excited synchronous machine having a stator with teeth which point to a rotor which has permanent magnets.

The following discussion of related art is provided to assist the reader in understanding the advantages of the invention, and is not to be construed as an admission that this related art is prior art to this invention.

Dynamoelectrical synchronous machines which are excited using permanent magnets, in particular permanent magnets of constant thickness, ideally have a rectangular exciter field. The harmonics contained in the rectangular field now lead, with the harmonics which result from the energized motor winding and the use of the stator, to pulsating and detent torques between the rotor and the stator. This influences, inter alia, the torque ripple and thus the machining quality of the workpieces machined by machine tools, for example.

In order to reduce these negative accompanying phenomena, U.S. Pat. No. 7,425,785 B2, for example, discloses the practice of configuring the surface of the permanent magnet in such a manner that an air gap field which is sinusoidal with some qualifications is produced. In this case, the inwardly pointing lower edge of the permanent magnet is straight or level. This rotor therefore has a contour which is in the form of an open polygon and on which the permanent magnets are situated.

However, for reasons of production technology, the permanent magnets cannot be arbitrarily thin in this case in their circumferential edge regions since otherwise there is a risk of the permanent magnets breaking, and this also leads to increased costs when producing the permanent magnets. These permanent magnets are therefore already “cropped” in their edge regions. The so-called “loaf of bread shape”, that is to say a flat base with a curved surface of the permanent magnet that faces the air gap of the electrical machine, is thus produced.

As a result of this measure, harmonics which are still responsible for detent and pulsating torques ultimately still remain in the air gap field.

A further solution for avoiding these pulsating and detent torques is to stagger or skew the permanent magnets on the rotor. Predetermined detent torques are thus reduced. However, on account of tolerances of the production means, the desired skew angles cannot be complied with exactly, with the result that detent and pulsating torques still remain.

German Offenlegungsschrift DE 100 41 329 A1 attempts to reduce torque ripple by means of a pole coverage of the surface of the rotor with permanent magnets of 70 to 80% to improve harmonic behavior. German Offenlegungsschrift DE 199 61 760 A1 attempts to reduce torque ripple, describing specific winding factors of a winding system of a dynamoelectrical machine, which system is arranged in slots, and a possible skew of the slots. A reduction in torque ripple and in detent and pulsating torques is also sought by configuring permanent magnets as disclosed in Japanese publication JP 2003230240 or published European Patent application EP 0 445 308 A1, for example.

It would be desirable and advantageous to provide an improved three-phase dynamoelectrical permanently excited synchronous machine to obviate prior art shortcomings and to significantly reduce detent and pulsating torques in comparison with the prior art.

### SUMMARY OF THE INVENTION

According to one aspect of the present invention, a three-phase dynamoelectrical permanently excited synchronous machine includes a stator with teeth which point to a rotor, twelve slots being formed between the teeth, which slots have coil sides of coils of a winding system in such a manner that two coil sides of different coils are situated in each slot, wherein the rotor has a cylindrical support structure which is provided with permanent magnets, the inner radius of which corresponds to the radius of the support structure and the outer radius of which is smaller than their inner radius, with the permanent magnets forming ten magnet poles when viewed in the circumferential direction.

According to another aspect of the present invention, a three-phase dynamoelectrical permanently excited synchronous machine includes a rotor having a cylindrical support structure provided with permanent magnets defined by an inner radius in correspondence to a radius of the support structure, and by an outer radius which is smaller than the inner radius, with the permanent magnets forming eight magnet poles when viewed in a circumferential direction, and a stator having teeth which point to the rotor, with the stator having twelve slots formed between the teeth for receiving coils of a winding system in such a manner that two coil sides of different coils are situated in each slot.

According to still another aspect of the present invention, a three-phase dynamoelectrical permanently excited synchronous machine includes a rotor having a cylindrical support structure provided with permanent magnets defined by an inner radius in correspondence to a radius of the support structure, and by an outer radius which is smaller than the inner radius, with the permanent magnets forming six magnet poles when viewed in a circumferential direction, and a stator having nine which point to the rotor, with the stator having none slots formed between the teeth for receiving coils of a winding system in such a manner that two coil sides of different coils are situated in each slot.

According to yet another aspect of the present invention, a three-phase dynamoelectrical permanently excited synchronous machine includes a rotor having a cylindrical support structure provided with permanent magnets defined by an inner radius in correspondence to a radius of the support structure, and by an outer radius which is smaller than the inner radius, with the permanent magnets forming four magnet poles when viewed in a circumferential direction, and a stator having nine which point to the rotor, with the stator having six slots formed between the teeth for receiving coils of a winding system in such a manner that two coil sides of different coils are situated in each slot.

As a result of the novel and inventive configuration of the rotor, in particular, the harmonics in the stator are significantly reduced, even in the case of a classic winding system, so that detent and pulsating torques occur only to a slight extent. In this case, a classic winding system comprises fractional-pitch coils, at least one slot of the stator that is unoccupied by a coil being situated between the forward and return conductors of this coil.

Tooth-wound coils in the stator give rise to far higher harmonics in the air gap field than classic winding systems, with the result that, whilst simultaneously simplifying the production of the stator, measures must be increasingly taken on the rotor to avoid or at least reduce these negative effects. In particular, the relationship of a twelve-slot stator with a ten-pole rotor or a twelve-slot stator with an eight-pole rotor or a nine-slot stator with a six-pole rotor or a six-slot stator with a four-pole rotor is extremely advantageous in this case.

This is because their lowest common multiple is far above other “slot/magnet pole” variants and thus already contributes to reducing the detent and pulsating torques by means of this configuration.

The permanent magnets which form the ten-pole, eight-pole, six-pole or four-pole rotor, for example, and are arranged on a support structure have different radii on the base and surface in order to be positioned directly on the cylindrical surface of the support structure. Additional air gaps between the support structure and the permanent magnet are therefore avoided, that is to say the radius of the base of the permanent magnet corresponds to the radius of the cylindrical outer surface of the support structure. This makes it possible to set selectable staggering angles in a simple manner without respectively adapting the structure of the rotor.

This support structure is advantageously designed in such a manner that there is magnetic conductivity. In the case of high rotational speeds above 10 000 rpm, it is advantageous if the eddy currents are suppressed and the support structure is in the form of a laminated core, in particular.

However, the support structure may also be composed of sintered material or of twist-proof plastic or of a magnetically conductive sleeve arranged on this plastic structure.

The surface of the permanent magnet, i.e. the surface facing the air gap of the dynamoelectrical machine, has a radius which is smaller than the radius of the base of the permanent magnet.

The levels of the harmonics in a permanently excited synchronous machine with a twelve-slot stator and a ten-pole rotor are advantageously reduced, in particular, when the outer radius of a permanent magnet corresponds to 0.5 to 0.9 times the inner radius of the permanent magnet.

It is advantageous in this case if the distance between the two radii is in the range of from 0.6 to 0.2 times or 0.85 to 0.2 times the inner radius.

The advantages described above appear in a permanently excited synchronous machine having a twelve-slot stator and an eight-pole rotor or a nine-slot stator and a six-pole rotor or a six-slot stator with a four-pole rotor, in particular, when the outer radius of a permanent magnet corresponds to 0.95 to 0.4 times the inner radius of the permanent magnet.

It is advantageous in this case if the distance between the two radii of the permanent magnets of a rotor is in the range of from 0.85 to 0.2 times the inner radius.

These measures make it possible to lower the edge of the permanent magnets, which contributes to a substantial reduction in the detent and pulsating torques.

As a result of the cylindrical configuration of the support structure, those permanent magnets whose base radius is identical to the outer radius of the support structure can also be staggered in any desired manner over the axial length of the rotor. The predefinable staggering makes it possible to deliberately mask or reduce harmonics, in particular the fifth and/or seventh harmonic.

Support structure shapes in the prior art which have a polygon structure do not permit such virtually arbitrarily selectable staggering since the polygon structure of the rotor laminates must be concomitantly staggered.

In order to further reduce the effects of the harmonics, the axially running lateral surfaces of the permanent magnets are parallel and are at a predefinable distance from the virtual points of intersection of the outer and inner radii. This distance is determined, inter alia, by the magnet material and by the desired reduction in the harmonics.

In one advantageous refinement, these permanent magnets have an antiparallel preferred direction of the lines of force. In this case, these permanent magnets are advantageously magnetized in a radial or quasi-radial manner, with the result that the preferred direction of their lines of force is not parallel and thus has a point of intersection in the virtual extension of these lines of force.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIGS. 1-3 show circuit variants of tooth-wound coils of a stator;

FIG. 4 shows a longitudinal view of a rotor;

FIG. 5 shows a side view of a rotor;

FIG. 6 shows a basic arrangement of a permanent magnet on a support structure;

FIG. 7 shows a cross section of a permanently excited synchronous machine;

FIG. 8 shows a side view of a rotor;

FIG. 9 shows a basic illustration of a permanent magnet;

FIGS. 10, 11 show arrangements of tooth-wound coils;

FIG. 12 shows an illustration of different staggering angles;

FIG. 13 shows a circuit variant of the tooth-wound coils of a twelve-slot stator;

FIG. 14 shows a circuit variant of the tooth-wound coils of a nine-slot stator;

FIG. 15 shows a cross section of a nine-slot stator with a six-pole rotor; and

FIG. 16 shows a cross section of a six-slot stator with a four-pole rotor.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

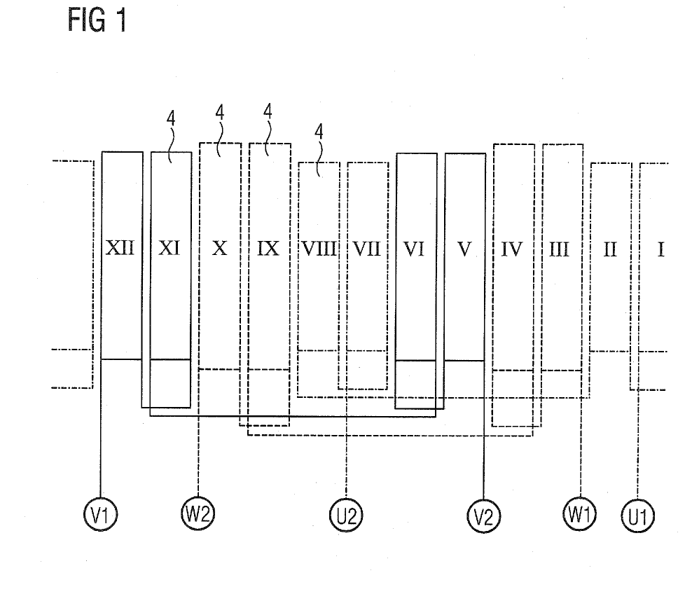

Turning now to the drawing, and in particular to FIG. 1-3, there are shown circuit diagrams of a three-phase U, V, W stator 2 of a permanently excited synchronous machine 1 with twelve slots 3, which stator is provided with a winding system which has tooth-wound coils 4 in the present exemplary embodiment. Each tooth-wound coil 4 comprises a tooth 5 of the stator 2 in such a manner that two coil sides of different tooth-wound coils 4 are situated in a slot 3. The tooth-wound coils 4 belonging to these coil sides of a slot 3 are assigned to one phase or to different phases.

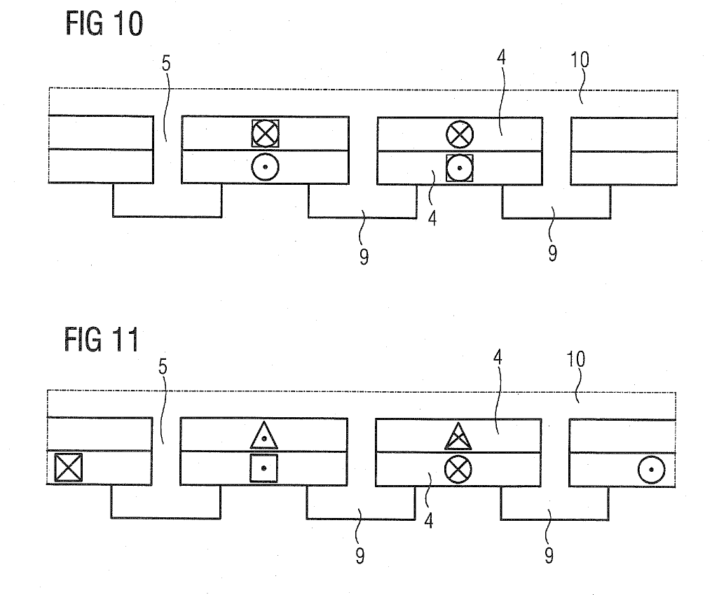

These coil sides are arranged beside one another but may likewise be arranged above one another and/or offset with respect to one another, as can be gathered, in principle, from FIGS. 10, 11. In this case, forward and return conductors, for example, are positioned differently in the slots 3, sometimes on the slot base 6 and sometimes in the slot slit 7. The stator 2 has a three-phase tooth-wound coil winding with four respective tooth-wound coils 4. In this case, the tooth-wound coils 4 in a phase are connected in series and/or in parallel. The aim here is to minimize the circuit complexity for connecting the tooth-wound coils 4 in a phase. With a connection according to FIG. 1, the tooth-wound coils 4 in the phase V are placed around the teeth V, VI, XI and XII. The tooth-wound coils 4 in the phase U are placed around the teeth VII, VIII, I and II in this case and the tooth-wound coils 4 in the phase W are placed around the teeth III, IV, IX and X.

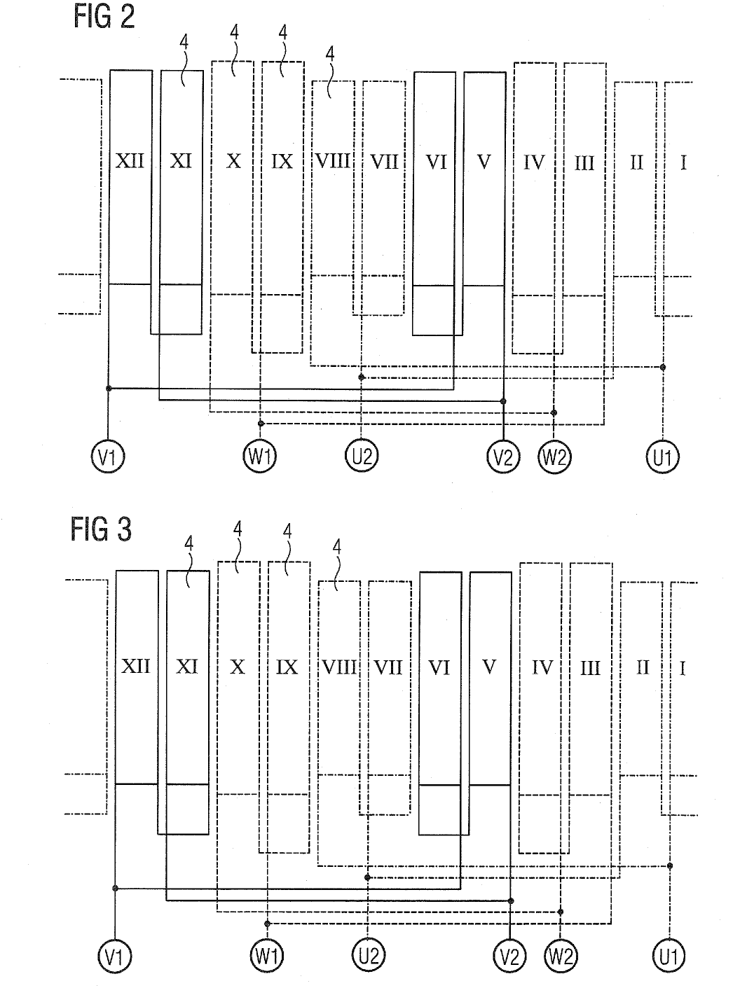

The winding schemes in FIGS. 2 and 3 essentially correspond to that in FIG. 1. The difference lies in the order in which the tooth-wound coils 4 in the respective phases are permeated by the current. In principle, the connection complexity is minimized in such a circuit arrangement whilst the electric loading is simultaneously maximized, which is ultimately again a question of the copper filling factor in the slot 3.

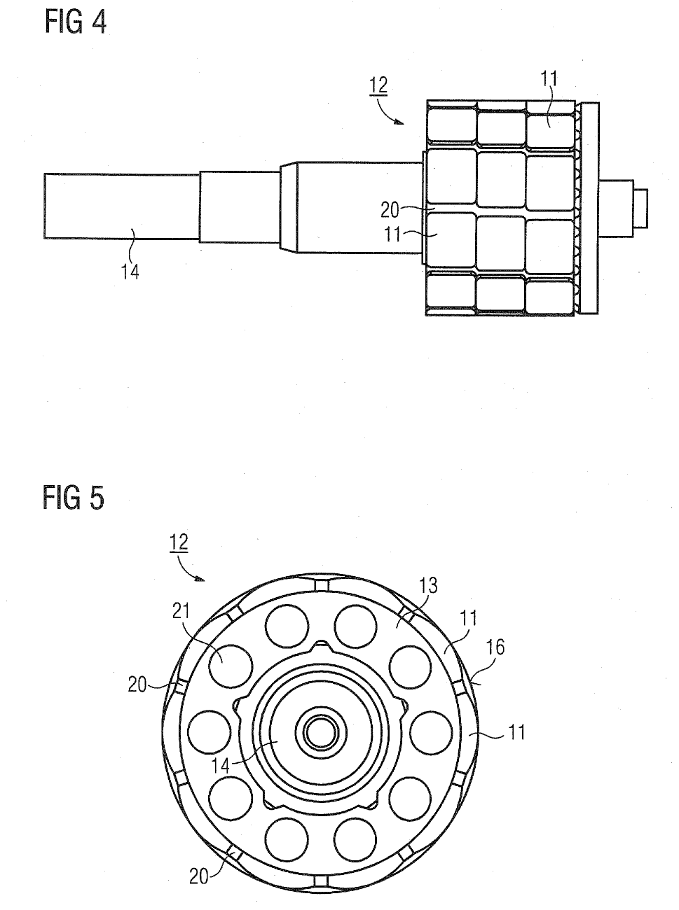

FIG. 4 shows a staggered arrangement of permanent magnets 11 of a rotor 12 in which permanent magnets 11 are applied to a cylindrical support structure 13 which causes a shaft 14 to rotate as a result of electromagnetic interaction with the winding system of the stator 2. In the present exemplary embodiment, the axial length I_{G} of the rotor 12 is fitted with three permanent magnets 11 for each magnet pole, the permanent magnets 11 each having an offset of a predefinable angle, preferably of approximately 2 degrees, with respect to the preceding permanent magnet 11, with the result that a constant staggered arrangement of the permanent magnets 11 is established when viewed over the entire axial length of the rotor 12. This achieves predefinable suppression of predefinable harmonics, for example the fifth and seventh harmonics. A pole gap 20 is respectively present between the magnet poles.

FIG. 5 shows a cross-sectional illustration of the rotor 12 with its support structure 13 and with permanent magnets 11 which are arranged on its surface and form a ten-pole rotor 12. The support structure 13 has recesses 21 which reduce, inter alia, the inertia of the rotor 12. As stated below, the permanent magnets 11 are positioned, for example adhesively bonded, directly on the cylindrical surface of the support structure 13, the inner radius RMagI of the base 15 of the permanent magnet 11 being identical to the radius of the support structure 13. In order to keep the permanent magnets 11 at their positions also during operation, provision is made, in particular, of a binding band 16 which fixes the permanent magnets 11 in a stationary manner.

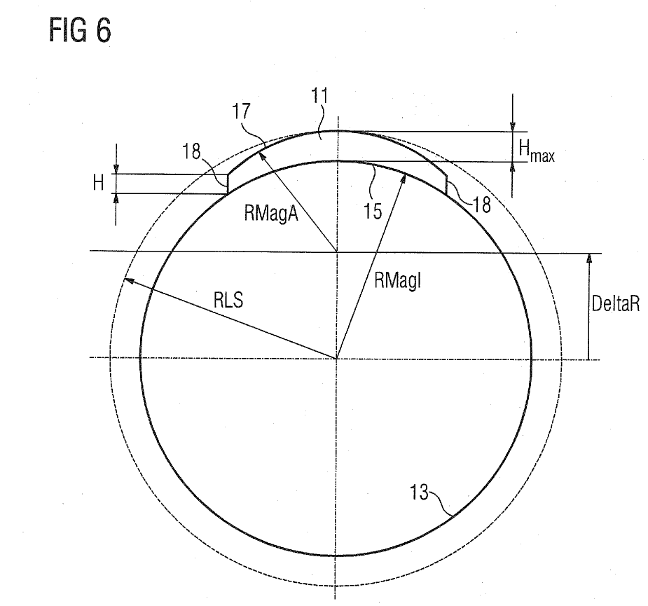

FIG. 6 shows a basic illustration of the geometrical dimensions of a permanent magnet 11 with its base 15 and with its surface 17 and the respective radii. In this case, the inner radius RMagI of the base 15 of the permanent magnet 11 corresponds to the outer radius of the support structure 13. The outer radius RMagA of the surface 17 of the permanent magnet 11 is smaller than the inner radius RMagI of the base 15 of the permanent magnet 11; it is preferably in the range of from 0.5 to 0.9 times the inner radius RMagI of the base 15 of the permanent magnet 11.

The difference between the abovementioned radii DeltaR is preferably in the range of from 0.6 RMagI to 0.2 RMagI.

As a result of this designed lowering of the edge of the permanent magnet 11 in the direction of its pole edges, the air gap field is brought more into line with a sine. Together with the twelve-slot configuration of the stator 2, virtually no abrupt changes in the field can now be determined in the zero crossing of the sinusoidal profile. This also reduces the losses in the laminated core 8 of the stator 2.

In order to further increase the effectiveness of the reduction in the pulsating and detent torques, the lateral surfaces 18 of the permanent magnets 11 are parallel to one another and have, for reasons of production technology, a height H which is ultimately considerably lower than the maximum height Hmax of the permanent magnet 11, preferably in its geometrical center.

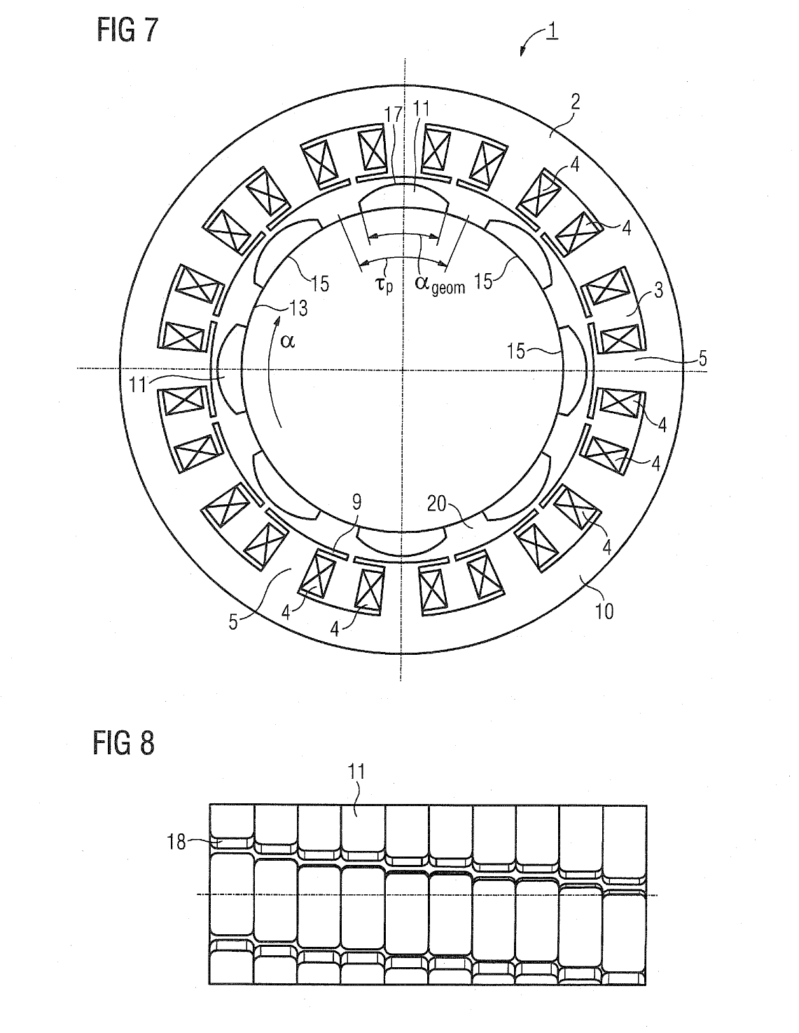

However, the lateral surfaces 18 may also be radial with respect to the shaft center point 28, as can be gathered from FIG. 7, for example.

A radius RLS of the rotor 12, which is increased, if appropriate, by the thickness of a binding band 16, thus results.

The permanent magnets 11 are advantageously magnetized in a radial manner, with the result that, with a virtual extension of the lines of force running in the permanent magnet 11, said lines of force would intersect at a virtual point 23 below the center point 28 of the rotor 12. The lines of force thus do not always run, in principle, perpendicularly from the surface 17; these lines of force are inclined in the direction of the center of the permanent magnet 11, in particular at the edge of the permanent magnets 11. This increases the demagnetization immunity, with the result that longevity of the drive is ensured with identical nominal data, in particular the nominal torque.

FIG. 7 shows a cross section of a permanently excited synchronous machine 1 with a rotor 12, the permanent magnets 11 of which are designed according to the invention. Two coil sides of two different tooth-wound coils 4 which are arranged beside one another in the circumferential direction a are situated in each slot 3. The laminated core 8 of the stator 2 is constructed in this case from a star yoke stack which can be axially fitted together, that is to say loose teeth 5 or teeth 5 which are contiguous with the tooth heads 9 in the circumferential direction and are inserted into a yoke rear 10, or single-piece sheets or loose teeth which can be fitted together, the tooth heads 9 being connected to the tooth shank by means of a form-fitting connection.

FIG. 8 shows a rotor 12 whose magnet poles comprise a plurality of permanent magnets 11 which do not have any staggering angle or have a predefinable staggering angle with respect to their respective preceding permanent magnet 11. This can be set in a comparatively simple manner on account of the cylindrical surface of the support structure 13.

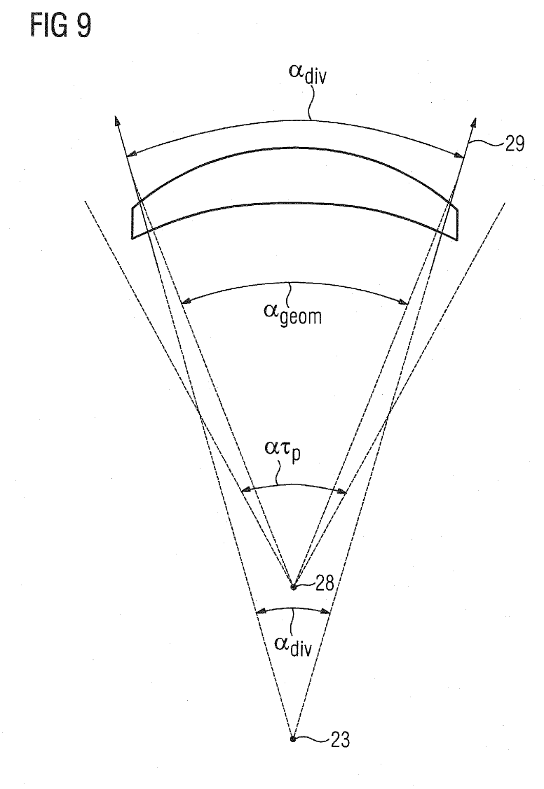

FIG. 9 shows another illustration of a permanent magnet 11 whose magnetic anisotropy is quasi-radial rather than parallel. Given a pole pitch of atₚ, the orientation 29 corresponds to the magnetic preferred direction of the lines of force a_{div} between the left-hand edge and the right-hand edge of the permanent magnet 11, i.e. in the range of a_{geom}:

a_{div}^{˜}0.5a_{geom}.

A point of intersection of these lines of force thus lies on that side of the rotor 12 which faces away from this permanent magnet 11.

FIGS. 10 and 11 show different arrangements of tooth-wound coils 4 in the slots 3, coil sides (forward and return conductors, that is to say cross and dot) of the same tooth-wound coils 4 being provided with the same geometrical markings, that is to say circle, triangle and square.

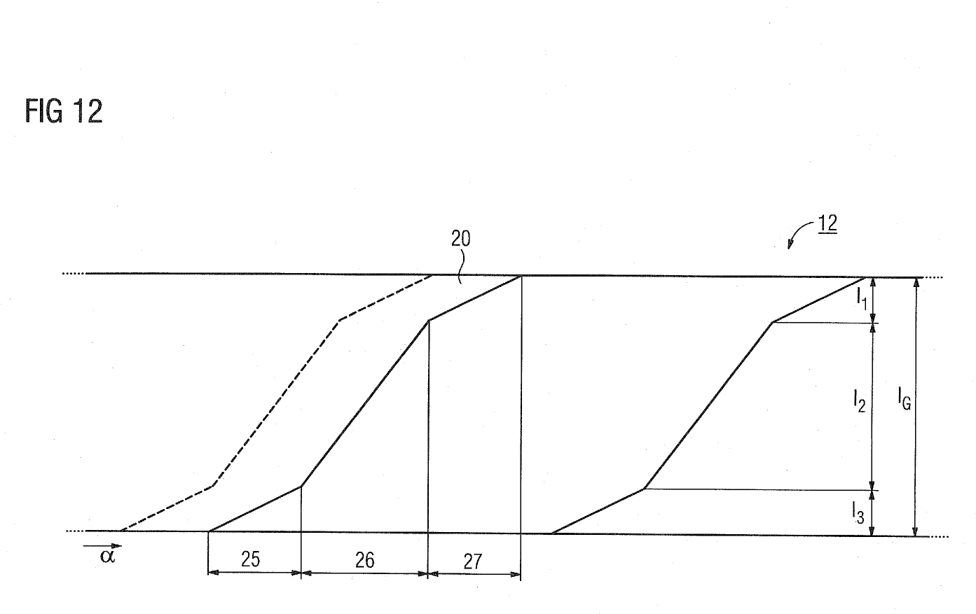

FIG. 12 shows a basic illustration of the axial length I_{G} of the rotor 12 which is subdivided into different axial sections I₁, I₂, I₃. Each axial section has different staggering angles, as can be gathered from the sections 25, 26, 27 in the circumferential direction a.

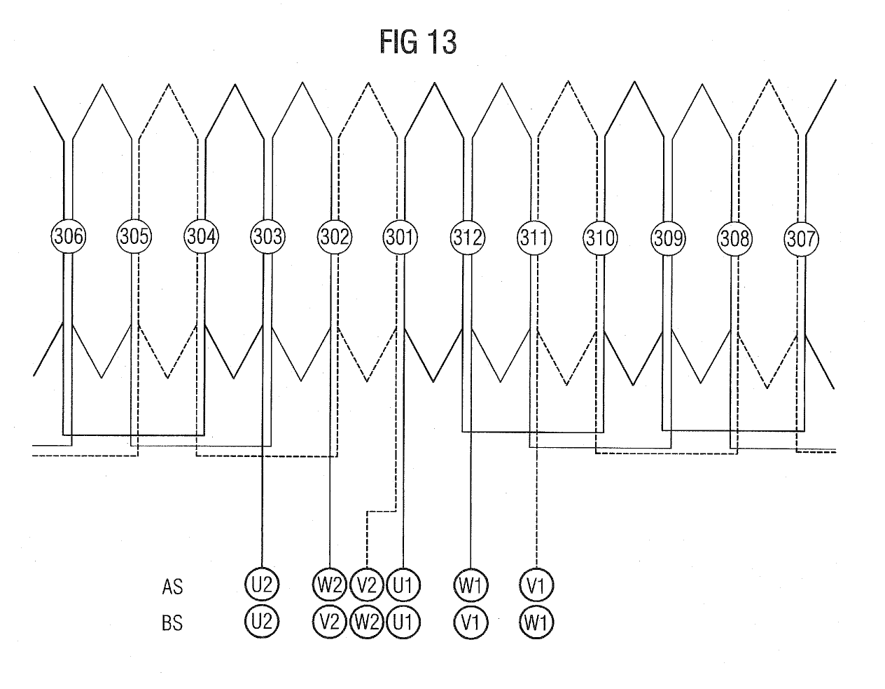

FIG. 13 shows a circuit variant of a permanently excited synchronous machine having a twelve-slot stator with an eight-pole rotor (not illustrated in any more detail).

FIG. 13 shows the circuit diagram of the three-phase U, V, W stator of a permanently excited synchronous machine 1 with twelve slots, which stator is provided with a winding system having tooth-wound coils 4 in the present exemplary embodiment. Each tooth-wound coil 4 comprises a tooth 5 of the stator 2 in such a manner that two coil sides of different tooth-wound coils 4 are situated in a slot. The tooth-wound coils 4 belonging to these coil sides of a slot 3 are assigned to one phase or to different phases.

These coil sides are arranged beside one another but may likewise be arranged above one another and/or offset with respect to one another, as can be gathered, in principle, from FIGS. 10, 11. In this case, forward and return conductors, for example, are positioned differently in the slots, sometimes on the slot base 6 and sometimes in the slot slit 7. The stator 2 according to FIG. 13 has a three-phase tooth-wound coil winding with four respective tooth-wound coils 4. In this case, the tooth-wound coils 4 in a phase are connected in series and/or in parallel. The aim here is to minimize the circuit complexity for connecting the tooth-wound coils 4 in a phase. With a connection according to FIG. 13, the tooth-wound coils 4 in the phases, for example, are arranged in the slots 301 to 312.

AS and BS are respectively used to denote the switching sides.

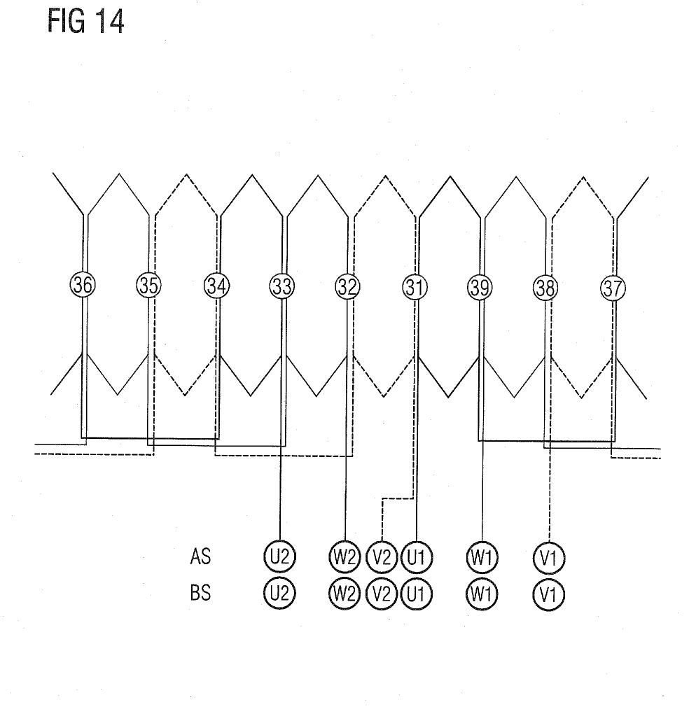

The statements made above likewise relate to a nine-slot stator according to FIG. 14 with the slots 31 to 39.

In the case of the winding schemes presented in FIGS. 1, 2, 3, 13, 14, the circuit complexity is, in principle, minimized whilst the electric loading is simultaneously maximized in the respective slot, which ultimately maximizes the copper filling factor in the slot again.

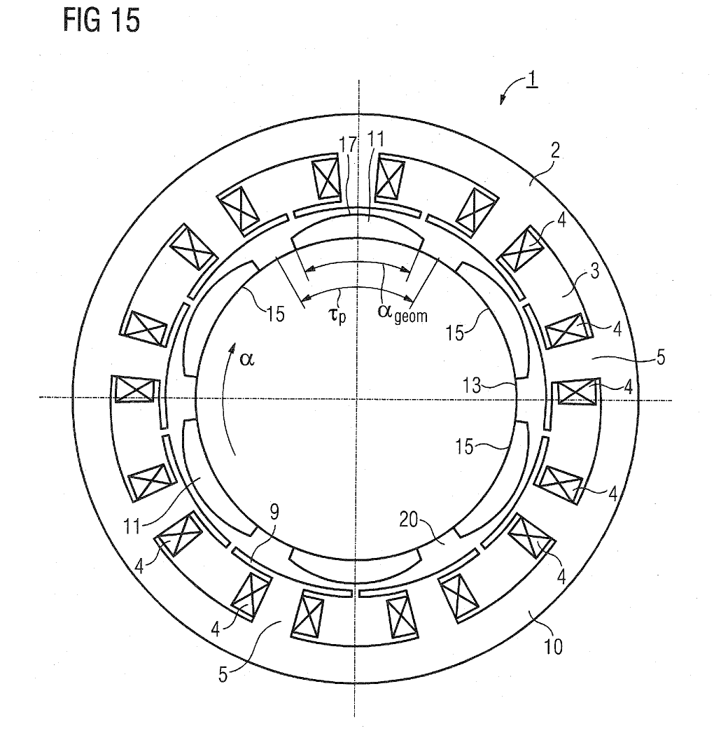

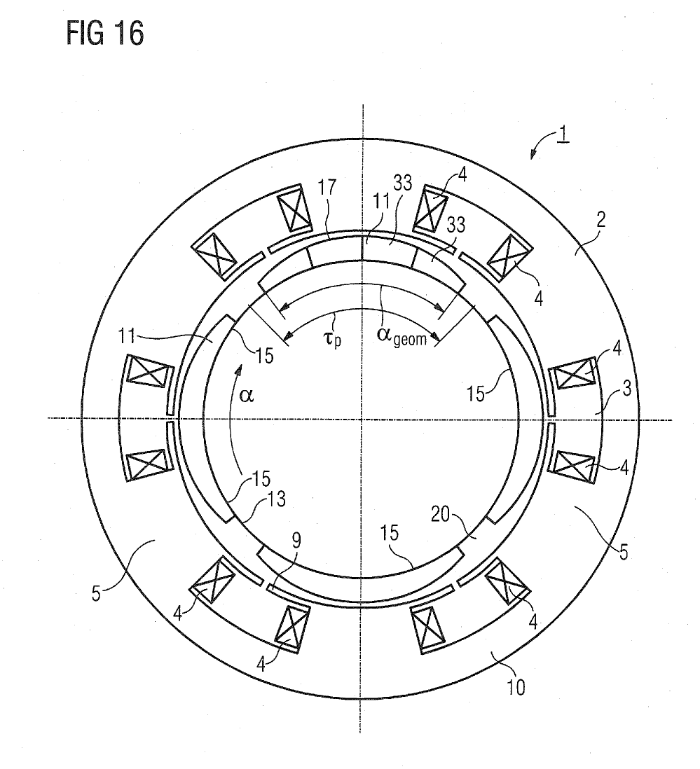

FIGS. 15, 16 show a cross-sectional illustration of a rotor 12 with its support structure 13 and with permanent magnets 11 which are arranged on its surface and form a six-pole or four-pole rotor 12. The support structure 13 advantageously has recesses 21 (according to FIG. 5) which are not illustrated in any more detail and reduce, inter alia, the inertia of the rotor 12. The permanent magnets 11 are positioned, for example adhesively bonded, directly on the cylindrical surface of the support structure 13, the inner radius RMagI of the base 15 of the permanent magnet 11 being identical to the radius of the support structure 13. In order to keep the permanent magnets 11 at their positions also during operation, provision is made, in particular, of a binding band 16 which fixes the permanent magnets 11 in a stationary manner.

The embodiment according to FIG. 16 shows permanent magnets 11 which are in a plurality of parts 33 when viewed in the circumferential direction. This is advantageous, in particular, in a four-pole rotor since the extent in the circumferential direction may be up to 90 degrees depending on the pole coverage.

This plurality of permanent magnets 33 facilitates production and transportation as well as handling, in particular during installation. These multipart permanent magnets 33 can naturally also be used in rotors with more poles, for example on rotors according to FIGS. 15, 5 and 7.

Two coil sides of two different tooth-wound coils 4 which are arranged beside one another in the circumferential direction a are situated in each slot 3. The laminated core 8 of the stator 2 is constructed in this case from a star yoke stack which can be axially fitted together, that is to say loose teeth 5 or teeth 5 which are contiguous with the tooth heads 9 in the circumferential direction and are inserted into a yoke rear 10, or single-piece sheets or loose teeth which can be fitted together, the tooth heads 9 being connected to the tooth shank by means of a form-fitting connection. In this case, FIG. 15 shows a nine-slot stator, whereas FIG. 16 shows a six-slot stator.

The statements made with respect to FIGS. 4 to 12 correspondingly apply to the exemplary embodiments illustrated in FIGS. 15 and 16, if this is technically expedient.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A three-phase dynamoelectrical permanently excited synchronous machine, comprising:
a rotor having a cylindrical support structure provided with permanent magnets defined by an inner radius in correspondence to a radius of the support structure, and by an outer radius which is smaller than the inner radius, said permanent magnets forming ten magnet poles when viewed in a circumferential direction; and
a stator having teeth which point to the rotor, said stator having twelve slots formed between the teeth for receiving coils of a winding system in such a manner that two coil sides of different coils are situated in each slot.

2. The three-phase dynamoelectrical permanently excited synchronous machine of claim 1, wherein the permanent magnets have a radial or quasi-radial magnetic anisotropy and thus a radial or quasi-radial orientation of their lines of force.

3. The three-phase dynamoelectrical permanently excited synchronous machine of claim 1, wherein the outer radius of the permanent magnets is in a range of from 0.9 to 0.5 times the inner radius of the permanent magnets.

4. The three-phase dynamoelectrical permanently excited synchronous machine of claim 1, wherein center points of radii of the outer radius and the inner radius of the permanent magnets are spaced at a distance in a range of from 0.2 to 0.6 times the inner radius.

5. The three-phase dynamoelectrical permanently excited synchronous machine of claim 1, wherein the rotor has predefinable different staggering angles of the permanent magnets when viewed over an axial length of the rotor.

6. The three-phase dynamoelectrical permanently excited synchronous machine of claim 4, wherein the rotor has axial sections with different staggering angles.

7. The three-phase dynamoelectrical permanently excited synchronous machine of claim 1, wherein edge regions of the permanent magnets, when viewed in the circumferential direction, define a height which is spaced at a predefinable distance from a point of intersection of the inner and outer radii of the permanent magnets, said permanent magnets having axial lateral surfaces extending in parallel relationship to one another.

8. The three-phase dynamoelectrical permanently excited synchronous machine of claim 7, wherein the permanent magnets have a radial anisotropy oriented in such a manner that a virtual extension of a profile of lines of force in the permanent magnet has a point of intersection on a side of a center point of the rotor which faces away from the respective permanent magnet.

9. A three-phase dynamoelectrical permanently excited synchronous machine, comprising:
a rotor having a cylindrical support structure provided with permanent magnets defined by an inner radius in correspondence to a radius of the support structure, and by an outer radius which is smaller than the inner radius, said permanent magnets forming eight magnet poles when viewed in a circumferential direction; and
a stator having teeth which point to the rotor, said stator having twelve slots formed between the teeth for receiving coils of a winding system in such a manner that two coil sides of different coils are situated in each slot.

10. The three-phase dynamoelectrical permanently excited synchronous machine of claim 9, wherein the permanent magnets have a radial or quasi-radial magnetic anisotropy and thus a radial or quasi-radial orientation of their lines of force.

11. The three-phase dynamoelectrical permanently excited synchronous machine of claim 9, wherein the outer radius of the permanent magnets is in a range of from 0.95 to 0.4 times the inner radius.

12. The three-phase dynamoelectrical permanently excited synchronous machine of claim 10, wherein center points of radii of the outer radius and the inner radius of the permanent magnets are spaced at a distance in a range of from 0.2 to 0.6 times the inner radius.

13. The three-phase dynamoelectrical permanently excited synchronous machine of claim 9, wherein the rotor has predefinable different staggering angles of the permanent magnets when viewed over an axial length of the rotor.

14. The three-phase dynamoelectrical permanently excited synchronous machine of claim 11, wherein the rotor has axial sections with different staggering angles.

15. The three-phase dynamoelectrical permanently excited synchronous machine of claim 9, wherein edge regions of the permanent magnets, when viewed in the circumferential direction, define a height which is spaced at a predefinable distance from a point of intersection of the inner and outer radii of the permanent magnets, said permanent magnets having axial lateral surfaces extending in parallel relationship to one another.

16. The three-phase dynamoelectrical permanently excited synchronous machine of claim 15, wherein the permanent magnets have a radial anisotropy oriented in such a manner that a virtual extension of a profile of lines of force in the permanent magnet has a point of intersection on a side of a center point of the rotor which faces away from the respective permanent magnet.

17. A three-phase dynamoelectrical permanently excited synchronous machine, comprising:
a rotor having a cylindrical support structure provided with permanent magnets defined by an inner radius in correspondence to a radius of the support structure, and by an outer radius which is smaller than the inner radius, said permanent magnets forming six magnet poles when viewed in a circumferential direction; and
a stator having teeth which point to the rotor, said stator having nine slots formed between the teeth for receiving coils of a winding system in such a manner that two coil sides of different coils are situated in each slot.

18. The three-phase dynamoelectrical permanently excited synchronous machine of claim 17, wherein the permanent magnets have a radial or quasi-radial magnetic anisotropy and thus a radial or quasi-radial orientation of their lines of force.

19. The three-phase dynamoelectrical permanently excited synchronous machine of claim 17, wherein the outer radius of the permanent magnets is in a range of from 0.95 to 0.4 times the inner radius.

20. The three-phase dynamoelectrical permanently excited synchronous machine of claim 18, wherein center points of radii of the outer radius and the inner radius of the permanent magnets are spaced at a distance in a range of from 0.2 to 0.6 times the inner radius.

21. The three-phase dynamoelectrical permanently excited synchronous machine of claim 17, wherein the rotor has predefinable different staggering angles of the permanent magnets when viewed over an axial length of the rotor.

22. The three-phase dynamoelectrical permanently excited synchronous machine of claim 19, wherein the rotor has axial sections with different staggering angles.

23. The three-phase dynamoelectrical permanently excited synchronous machine of claim 17, wherein edge regions of the permanent magnets, when viewed in the circumferential direction, define a height which is spaced at a predefinable distance from a point of intersection of the inner and outer radii of the permanent magnets, said permanent magnets having axial lateral surfaces extending in parallel relationship to one another.

24. The three-phase dynamoelectrical permanently excited synchronous machine of claim 23, wherein the permanent magnets have a radial anisotropy oriented in such a manner that a virtual extension of a profile of lines of force in the permanent magnet has a point of intersection on a side of a center point of the rotor which faces away from the respective permanent magnet.

25. A three-phase dynamoelectrical permanently excited synchronous machine, comprising:
a rotor having a cylindrical support structure provided with permanent magnets defined by an inner radius in correspondence to a radius of the support structure, and by an outer radius which is smaller than the inner radius, said permanent magnets forming four magnet poles when viewed in a circumferential direction; and
a stator having teeth which point to the rotor, said stator having six slots formed between the teeth for receiving coils of a winding system in such a manner that two coil sides of different coils are situated in each slot.

26. The three-phase dynamoelectrical permanently excited synchronous machine of claim 25, wherein the permanent magnets have a radial or quasi-radial magnetic anisotropy and thus a radial or quasi-radial orientation of their lines of force.

27. The three-phase dynamoelectrical permanently excited synchronous machine of claim 25, wherein the outer radius of the permanent magnets is in a range of from 0.95 to 0.4 times the inner radius.

28. The three-phase dynamoelectrical permanently excited synchronous machine of claim 26, wherein center points of radii of the outer radius and the inner radius of the permanent magnets are spaced at a distance in a range of from 0.2 to 0.6 times the inner radius.

29. The three-phase dynamoelectrical permanently excited synchronous machine of claim 25, wherein the rotor has predefinable different staggering angles of the permanent magnets when viewed over an axial length of the rotor.

30. The three-phase dynamoelectrical permanently excited synchronous machine of claim 25, wherein the rotor has axial sections with different staggering angles.

31. The three-phase dynamoelectrical permanently excited synchronous machine of claim 25, wherein edge regions of the permanent magnets, when viewed in the circumferential direction, define a height which is spaced at a predefinable distance from a point of intersection of the inner and outer radii of the permanent magnets, said permanent magnets having axial lateral surfaces extending in parallel relationship to one another.

32. The three-phase dynamoelectrical permanently excited synchronous machine of claim 31, wherein the permanent magnets have a radial anisotropy oriented in such a manner that a virtual extension of a profile of lines of force in the permanent magnet has a point of intersection on a side of a center point of the rotor which faces away from the respective permanent magnet.
